(19) United States
(12) Patent Application Publication
(10) Pub. No.: US 2004/0221651 A1
(43) Pub. Date: Nov. 11, 2004

(54) Force balanced piezoelectric rate sensor

(76) Inventor: Peter J. Schiller, Coon Rapids, MN (US)

Correspondence Address: Min (Amy) S. Xu, DORSEY & WHITNEY LLP, Intellectual Property Department, 50 South Sixth Street, Suite 1500, Minneapolis, MN, 55402-1498, US

(21) Appl. No.: 10/841,905

(22) Filed: May 7, 2004

Related U.S. Application Data
(60) Provisional application No. 60/468,785, filed on May 8, 2003.

(51) Int. Cl. G01P 15/09

(52) U.S. Cl. 73/514.34

(57) ABSTRACT

The present invention provides a solid-state rotational rate sensor device formed by thin films for generating an electrical signal output proportional to the rate of rotation. The precision thin-film piezoelectric elements are configured and arranged on a semi-rigid structure to detect rotational rate while rejecting spurious noise created by package strain, thermal gradients, vibration, and electromagnetic interference.

### CROSS-REFERENCE TO RELATED APPLICATION(S)

The present utility patent application claims priority of U.S. Provisional Patent Application, Serial No. 60/468,785, filed May 8, 2003; subject matter of which is incorporated herewith by reference.

### FIELD OF THE INVENTION

The present invention relates generally to a piezoelectric sensor device and method, and more particularly, to a solid-state piezoelectric sensor device and method for measuring rotational rate.

### BACKGROUND OF THE INVENTION

Piezoelectric materials are used in a variety of sensors and actuators. Piezoelectric materials convert mechanical energy to electrical energy and vice versa. For instance, if pressure is applied to a piezoelectric crystal, an electrical signal is generated in proportion thereby producing the function of a sensor. Generation of an electrical signal in response to an applied force or pressure is known as the “primary piezoelectric effect”. Similarly, if an electrical signal is applied to a piezoelectric crystal, it will expand in proportion as an actuator. Geometric deformation (expansion or contraction) in response to an applied electric signal is known as the “secondary piezoelectric effect”. Whether operated as a sensor or actuator, electrically-conductive electrodes must be appropriately placed on the piezoelectric crystal for collection or application of the electrical signal, respectively. Therefore, a piezoelectric sensor (actuator) consists nominally of a) a portion of piezoelectric material, and b) electrically-conductive electrodes suitably arranged to transfer electrical energy to (from) an external electrical circuit.

Piezoelectric materials have been utilized in the art to create a variety of simple sensors and actuators. Examples of sensors include vibration sensors, microphones, and ultrasonic sensors. Examples of actuators include ultrasonic transmitters and linear positioning devices. However, in most of these examples, bulk piezoelectric material is machined and assembled in a coarse manner to achieve low-complexity devices.

Therefore, there is a need for an improved piezoelectric rotational rate sensor device and method.

### SUMMARY OF THE INVENTION

To solve the above and the other problems, the present invention provides a solid-state rotational rate sensor, or just “rate sensor”, formed by thin films. Similar to silicon Integrated Circuits (ICs), a rate sensor in accordance with the present invention is built up by a series of thin films, typically less than or about 5 micron (0.005 mm) in thickness. A rate sensor is designed to generate an electrical voltage output proportional to the rate of rotation.

The present invention provides precision thin-film piezoelectric elements on a semi-rigid structure to detect rotational rate while rejecting spurious noise created by package strain, thermal gradients, vibration, and electromagnetic interference. During normal operation, selected piezoelectric elements on the rate sensor structure are driven by a first periodic electrical signal to create a controlled mechanical oscillation. When the rate sensor is subjected to rotation, a characteristic second electrical signal is produced across other piezoelectric elements on the rate sensor, according to the primary piezoelectric effect. These second electrical signals are amplified and filtered through associated electrical circuitry to extract high-fidelity signals proportional to the rotational rate.

The present invention utilizes piezoelectric materials in a thin-film format. The thin-film distinction enables transducers with a far higher degree of complexity and accuracy. Thin-films offer at least the following advantages:

Matching—Thin-film piezoelectric materials are deposited and defined on an atomic scale utilizing fabrication processes common in the semiconductor industry. The result is that thin-film piezoelectric elements can be consistently manufactured with element matching more than 100× better than conventional bulk machined devices.

Density—Thin-film piezoelectric elements are defined using microlithography, a process which enables extremely small dimensions (less than 0.001 mm, or 1 micron) to be delineated in a consistent and controlled manner. The result is that a large number of precision piezoelectric elements can be defined on a single microscopic transducer device.

Accuracy—In a thin-film format, piezoelectric materials exhibit reduced levels of random noise. At system level, the effect of lower noise is higher accuracy readings.

Low-Cost—Thin-film piezoelectric elements are defined using batch processing techniques common in the semiconductor industry. A typical deposition, pattern transfer, and etch sequence on a single silicon wafer defines literally millions of precision piezoelectric elements on thousands of transducers.

Size—Thin-film piezoelectrics enable far smaller devices to be manufactured.

Low Power—Less energy is required to operate a thin-film device.

The above advantages are inherent to the present invention and enable novel configurations and unique features that increase the overall device and system performance.

These and other features and advantages of the present invention will become apparent to those skilled in the art from the following detailed description, wherein it is shown and described illustrative embodiments of the invention, including best modes contemplated for carrying out the invention. As it will be realized, the invention is capable of modifications in various obvious aspects, all without departing from the spirit and scope of the present invention. Accordingly, the drawings and detailed description are to be regarded as illustrative in nature and not restrictive.

### BRIEF DESCRIPTION OF THE DRAWINGS

FIG. 1 is a cross-sectional view of one embodiment of a solid-state rate sensor device, in accordance with the principles of the present invention.

FIG. 2 is a top view of one embodiment of a solid-state rate sensor device showing one arrangement of piezoelectric element placement.

FIG. 3 is a cross-sectional view of one embodiment of a solid-state rate sensor device illustrating internal motion along a direction perpendicular to the device surface.

FIG. 4 is a cross-sectional view of one embodiment of a solid-state rate sensor device illustrating internal motion along a direction parallel to the device surface.

FIG. 5 is a top view of one embodiment of a solid-state rate sensor device showing another arrangement of piezoelectric element placement.

FIG. 6 is a cross-sectional view of one embodiment of a solid-state rate sensor device illustrating a mass center of a seismic-mass and coordinate system.

FIG. 7 is a top view diagram of the seismic-mass in one embodiment of a solid-state rate sensor device illustrating motion of the seismic-mass partially a long a first coordinate direction and partially along a second coordinate direction, the first and second coordinate directions being parallel to the surface plane of the device.

FIG. 8 is a cross-sectional diagram of the seismic-mass in a further embodiment of a solid-state rate sensor device illustrating motion of the seismic-mass partially along a first coordinate direction and partially along a second coordinate direction, the first coordinate direction being perpendicular to the surface plane of the device and the second coordinate direction being parallel to the surface plane of the device.

FIG. 9 is a cross-sectional diagram of the seismic-mass in a further embodiment of a solid-state rate sensor device illustrating motion of the seismic-mass partially along a first coordinate direction and partially along a third coordinate direction, the first coordinate direction being perpendicular to the surface plane of the device and the third coordinate direction being parallel to the surface plane of the device.

FIG. 10 is an electrical diagram showing an embodiment for the electrical interconnections of the piezoelectric elements in FIG. 2 for implementation as a solid-state rate sensor device, in accordance with the principles of the present invention.

FIG. 11 is an electrical diagram showing a further embodiment for the electrical interconnections of the piezoelectric elements in FIG. 5 for implementation as a solid-state rate sensor device, in accordance with the principles of the present invention.

FIG. 12 is an electrical diagram showing an embodiment of interconnections between the FIG. 10 device and interface electronic components for applying and extracting electrical signals to and from the FIG. 10 device.

FIG. 13 is an electrical diagram showing a further embodiment of interconnections between the FIG. 11 device and interface electronic components for applying and extracting electrical signals to and from the FIG. 11 device.

FIG. 14 is an electrical block diagram showing an embodiment of general interconnections for electronics that will interface with the components in FIG. 12.

FIG. 15 is an electrical block diagram showing a further embodiment of general interconnections for electronics that will interface with the components in FIG. 13.

FIG. 16 is a detailed electrical diagram showing an embodiment of electronic components in drive electronics that interface with the components in FIG. 12.

FIG. 17 is a detailed electrical diagram showing a further embodiment of electronic components in the drive electronics that will interface with the components in FIG. 13.

FIG. 18 is a detailed electrical diagram showing an embodiment of a single-axis rate sensor according to the present invention wherein the components of FIG. 12 and the components of FIG. 14 are connected to each other and to an additional amplifier to generate on output electrical signal proportional to rotational rate.

FIG. 19 is a detailed electrical diagram showing an embodiment of a multi-axis rate sensor according to the present invention wherein the components of FIG. 13 and the components of FIG. 15 are connected to each other and to additional amplifiers to simultaneously generate a plurality of output electrical signals each proportional to rotational rate about two different directions.

FIG. 20 is a detailed electrical diagram showing an embodiment of a single-axis rate sensor according to the present invention wherein the components of FIG. 12 and the components of FIG. 14 are connected to each other and to an additional phase shift detection circuit to generate an output electrical signal proportional to rotational rate.

FIG. 21 is a detailed electrical diagram showing an embodiment of a multi-axis rate sensor according to the present invention wherein the components of FIG. 13 and the components of FIG. 15 are connected to each other and to additional phase shift detection circuits to simultaneously generate a plurality of output electrical signals each proportional to rotational rate about two different directions.

FIG. 22 is an electrical schematic illustrating one embodiment of a phase shift detection circuit shown in FIG. 20 for converting the phase shift of two periodic signals to an electrical signal output according to the present invention.

### DETAILED DESCRIPTION OF THE PREFERRED EMBODIMENTS

The present invention provides a solid-state rate sensor device formed by thin films for generating an electrical signal output proportional to rotational rate. The precision thin-film piezoelectric elements are configured and arranged on a semi-rigid structure to detect rotational rate while rejecting spurious noise created by package strain, vibration, thermal gradients, and electromagnetic interference.

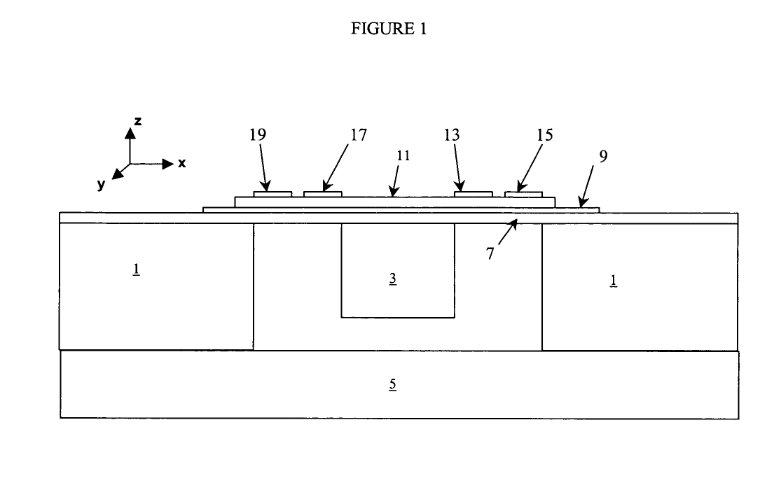

One embodiment of a solid-state rotational rate device (also referred to as just “rate sensor”) is shown in FIG. 1. The device includes a) a cylindrical silicon seismic-mass 3 that is suspended on b) a toroidal thin-film membrane 7 on which are c) a series of thin-film piezoelectric elements 13, 15, 17, and 19. Typically, the height of the seismic-mass 3 is about 500 microns, the diameter of the seismic-mass 3 is about 400 microns, while the outer diameter of the membrane toroid 7 is about 700 microns. The membrane toroid 7 can be realized with a variety of different materials that exhibit flexibility, resistance to fatigue, and good thermal expansion match to the surrounding silicon substrate. Preferred materials for the membrane are single-crystal silicon, polycrystalline silicon, and silicon nitride with a typical thickness of about 1 micron. However, some rate sensors designed for high frequency or high range applications would utilize a much thicker membrane. The piezoelectric elements are formed from a single layer of metal (preferably platinum about 0.1 microns thick) that forms a common lower electrode 9 and a single layer of piezoelectric thin film 11 (preferably PZT about 1 micron thick). By utilizing a single common layer for the lower electrode and piezoelectric film, matching between elements and element density is increased; these factors improve the rate sensor's signal fidelity. The piezoelectric elements are defined by upper metal electrodes 13, 15, 17, and 19 (preferably platinum about 0.1 microns thick). Since the piezoelectric thin film 11 is non-conductive, each piezoelectric element 13, 15, 17, or 19 is defined by the upper electrode alone, and electrical interaction between elements is negligible.

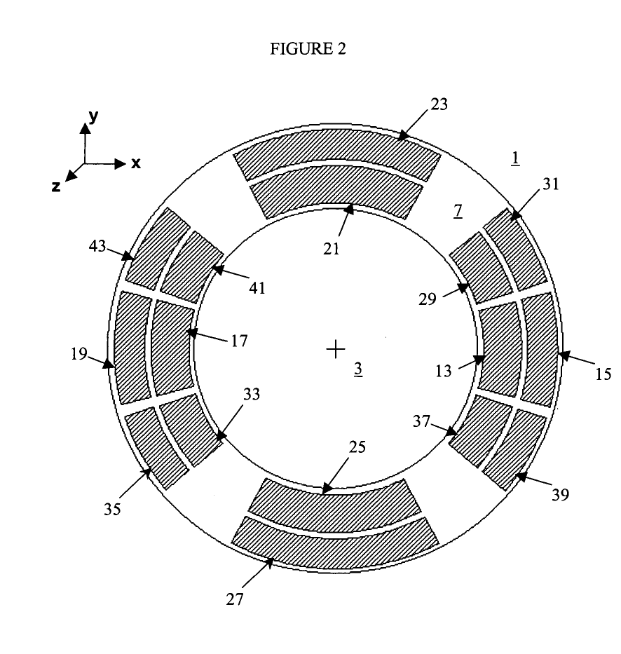

A first embodiment of piezoelectric element configuration for a solid-state rate sensor is detailed in FIG. 2, and it includes matched differential pairs (i.e. 13 and 15) that reside on adjacent inner and outer regions of the membrane toroid. Each pair is configured for optimal matching; they have identical electrode area, are placed at minimum spacing, and are symmetrically located on the semi-rigid toroidal membrane. In addition, an identical mirror-image pair is located on the opposite side of the seismic-mass (i.e. 13/15 and 17/19 represent a mirror-image pair). During operation as a rate sensor, these 4-element mirror-image pairs will selectively generate differential voltages associated with motion along a single direction. During operation as an actuator, these 4-element mirror-image pairs will selectively generate motion along a single direction. Whether operated as a sensor or actuator, the differential nature and symmetric placement along the coordinate axes allows motion in other directions to be rejected, thereby increasing the signal accuracy. The amount of “off-axis rejection” is strongly related to a) the symmetry b) matching of the elements, and c) precision placement. These are some of the advantages of the present invention that yield dramatically improved performance over the prior art. A multitude of additional electrode configurations can be used within the scope of the present invention and are known in the electrical art. The arrangement of FIG. 2 depicts one of many suitable centro-symmetric (symmetry in a cylindrical coordinate system) arrangements of differential piezoelectric elements.

Specifically, the matched elements 15/13 and 19/17 as shown in FIG. 2 are selective to motion along the X-axis. The matched elements 23/21 and 27/25 as shown in FIG. 2 are selective to motion along the Y-axis. The matched elements 31/29 and 35/33 as shown in FIG. 2 are selective to motion along a direction in part along the X-axis and in part along the Y-axis. The matched elements 39/37 and 43/41 as shown in FIG. 2 are also selective to motion along a direction in part along the X-axis and in part along the Y-axis. The delineation of directions as “X-axis” and “Y-axis” is used here for illustrative purposes.

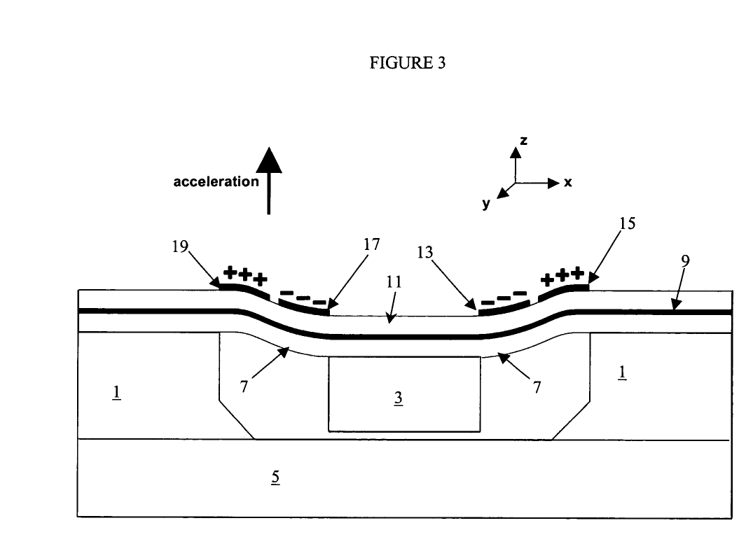

FIG. 3 illustrates a cross section of an embodiment of the present invention when configured as a sensor with acceleration in the vertical direction perpendicular to the device surface. During a vertical acceleration, the seismic-mass 3 deflects in a symmetric manner towards the underlying silicon substrate. According to the primary piezoelectric effect, piezoelectric elements 15 and 19 (corresponding to electrodes 15 and 19) generate an electrical output signal of first polarity in proportion to the acceleration magnitude. At the same time and also according to the primary piezoelectric effect, piezoelectric elements 13 and 17 (corresponding to electrodes 13 and 17) generate an electrical output signal of second polarity in proportion to the acceleration magnitude. The opposing electrical output signal polarities generated by the piezoelectric elements is a result of the bending moment: electrode 15 and electrode 19 are bent with downward concavity while electrode 13 and electrode 17 are bent with upward concavity. The opposing electrical output signal polarity is the reason for arranging the piezoelectric elements into differential pairs. Under normal physical motion, one element in the differential pair generates a positive electrical output signal while the other element in the differential pair generates a negative electrical output signal.

FIG. 3 also illustrates a cross section of an embodiment of the present invention when configured as an actuator with motion in the vertical direction. During a vertical actuation, the seismic-mass deflects in a symmetric manner towards the underlying silicon substrate. According to the secondary piezoelectric effect, piezoelectric elements 15 and 19 (corresponding to electrodes 15 and 19) generate a mechanical bending moment of first polarity in proportion to an applied electrical signal of first polarity. At the same time and also according to the secondary piezoelectric effect, piezoelectric elements 13 and 17 (corresponding to electrodes 13 and 17) generate a mechanical bending moment of second polarity in proportion to an applied electrical signal of second polarity. The opposing bending moment polarities generated by the piezoelectric elements is a result of the opposing electrical signals applied: electrode 15 and electrode 19 are bent with downward concavity while electrode 13 and electrode 17 are bent with upward concavity. The opposing bending moment polarity is one of the reasons for arranging the piezoelectric elements into differential pairs. During actuation according to the present invention, one element in the differential pair generates a positive bending moment while the other element in the differential pair generates a negative bending moment. The motion of the seismic-mass is thereby controlled when the piezoelectric elements are configured as actuators.

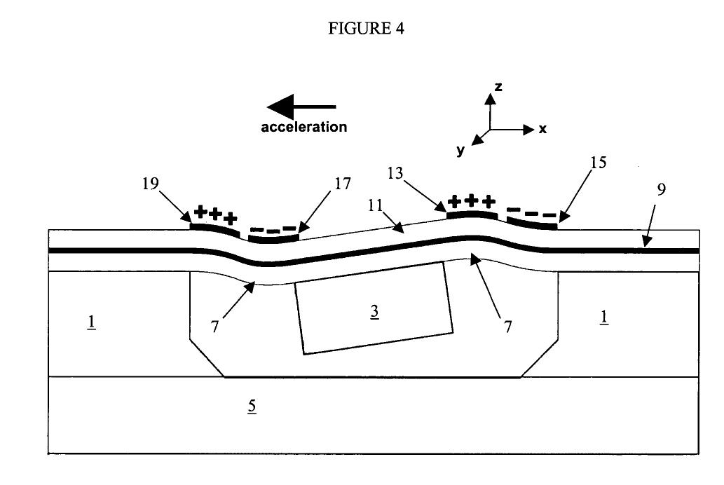

FIG. 4 illustrates a cross section of an embodiment of the present invention when configured as a sensor and subjected to acceleration in a first lateral direction parallel to the device surface. During a lateral acceleration, the seismic-mass 3 creates a lateral force on the membrane toroid 7 causing it to deflect laterally in an anti-symmetric manner. According to the primary piezoelectric effect, piezoelectric elements 19 and 13 (corresponding to electrodes 19 and 13) generate an electrical output signal of first polarity in proportion to the acceleration magnitude. At the same time and also according to the primary piezoelectric effect, piezoelectric elements 15 and 17 (corresponding to electrodes 15 and 17) generate an electrical output signal of second polarity in proportion to the acceleration magnitude. The opposing electrical output signal polarities generated by the piezoelectric elements is a result of the bending moment: electrode 19 and electrode 13 are bent with downward concavity while electrode 15 and electrode 17 are bent with upward concavity. The opposing electrical output signal polarity is one of the reasons for arranging the piezoelectric elements into differential pairs. Under normal physical motion, one element in the differential pair generates a positive electrical output signal while the other element in the differential pair generates a negative electrical output signal.

FIG. 4 also illustrates a cross section of an embodiment of the present invention when configured as an actuator with motion in a lateral direction. During a lateral actuation, the seismic-mass 3 deflects in an anti-symmetric manner parallel to the underlying silicon substrate. According to the secondary piezoelectric effect, piezoelectric elements 15 and 17 (corresponding to electrodes 15 and 17) generate a mechanical bending moment of first polarity in proportion to an applied electrical signal of first polarity. At the same time and also according to the secondary piezoelectric effect, piezoelectric elements 19 and 13 (corresponding to electrodes 19 and 13) generate a mechanical bending moment of second polarity in proportion to an applied electrical signal of second polarity. The opposing bending moment polarities generated by the piezoelectric elements is a result of the opposing electrical signals applied: electrode 19 and electrode 13 are bent with downward concavity while electrode 15 and electrode 17 are bent with upward concavity. The opposing bending moment polarity is one of the reasons for arranging the piezoelectric elements into differential pairs. During actuation according to the present invention, one element in the differential pair generates a positive bending moment while the other element in the differential pair generates a negative bending moment. The motion of the seismic-mass is thereby controlled when the piezoelectric elements are configured as actuators.

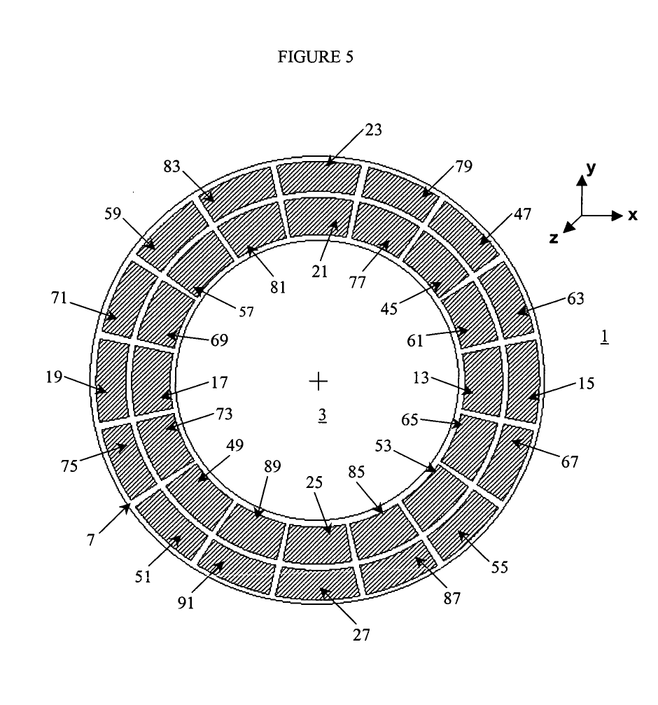

A further embodiment of piezoelectric element configuration for a solid-state rate sensor is detailed in FIG. 5, and it includes matched differential pairs (i.e. 15 and 13) that reside on adjacent inner and outer regions of the membrane toroid 7. Each pair is configured for optimal matching; they have identical electrode area, are placed at minimum spacing, and are symmetrically located on the semi-rigid toroidal membrane. In addition, an identical mirror-image pair is located on the opposite side of the seismic-mass (i.e. 15/13 and 19/17 represent a mirror-image pair; 63/61 and 75/73 represent a mirror-image pair). During operation as a rate sensor, these 4-element mirror-image pairs will selectively generate differential voltages associated with motion along a single direction. During operation as an actuator, these 4-element mirror-image pairs will selectively generate motion along a single direction. Whether operated as a sensor or actuator, the differential nature and symmetric placement along the coordinate axes allows motion in other directions to be rejected, thereby increasing the signal accuracy. The amount of “off-axis rejection” is strongly related to a) the symmetry b) matching of the elements, and c) precision placement. These are some of the advantages of the present invention that yield dramatically improved performance over the prior art. A multitude of additional electrode configurations can be used within the scope of the present invention and are known in the electrical art. The arrangement of FIG. 5 depicts one of many suitable centro-symmetric (symmetry in a cylindrical coordinate system) arrangements of differential piezoelectric elements.

Specifically, the matched elements 15/13 and 19/17 as shown in FIG. 5 are selective to motion along the X-axis. The matched elements 23/21 and 27/25 as shown in FIG. 5 are selective to motion along the Y-axis. The matched elements 63/61 and 67/65 as shown in FIG. 5 are selective to motion along a direction in part along the X-axis and in part along the Z-axis. The matched elements 71/69 and 75/73 as shown in FIG. 5 are also selective to motion along a direction in part along the X-axis and in part along the Z-axis. The matched elements 79/77 and 83/81 as shown in FIG. 5 are selective to motion along a direction in part along the Y-axis and in part along the Z-axis. The matched elements 87/85 and 91/89 as shown in FIG. 5 are also selective to motion along a direction in part along the Y-axis and in part along the Z-axis. Lastly, the elements 47/45, 59/57, 55/53, and 51/49 as shown in FIG. 5 are selective to motion along the Z-axis. The delineation of directions as “X-axis”, “Y-axis”, and “Z-axis” is used here for illustrative purposes.

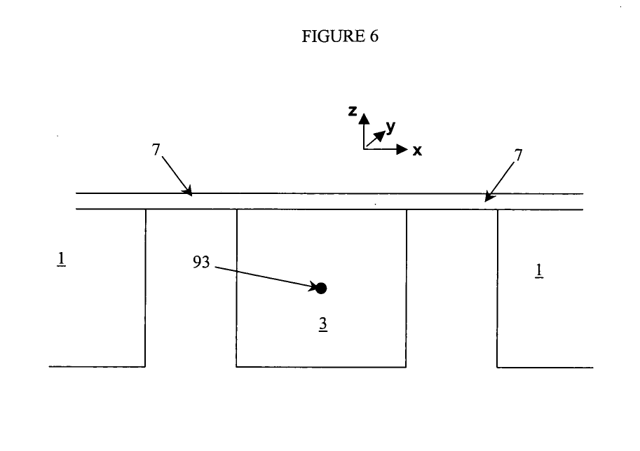

FIG. 6 is a general cross-sectional view of one embodiment of a solid-state rate sensor device illustrating a mass center 93 of the seismic-mass 3 and coordinate system. The mass center 93 of the seismic-mass 3 represents the symmetry point about which the elements are placed on the membrane. The coordinate directions are defined in FIG. 6 where the “X-axis” and “Y-axis” are both parallel to the surface plane of the device and perpendicular to each other. The “Z-axis” in FIG. 6 is perpendicular to the surface plane of the device and perpendicular to the “X-axis” and “Y-axis”. The delineation of directions as “X-axis”, “Y-axis”, and “Z-axis” is used here for illustrative purposes.

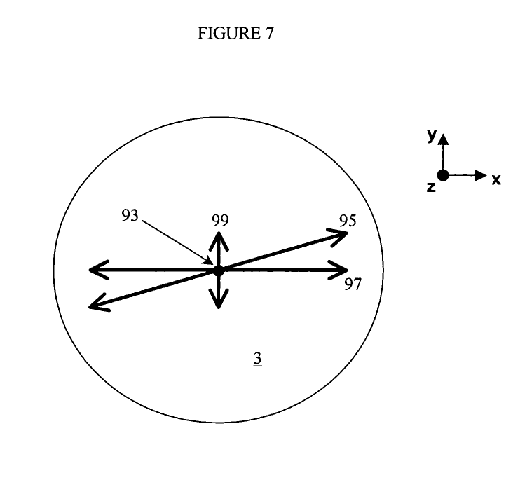

FIG. 7 is a top view simplified representation of the present invention depicting motion of the seismic-mass 3 along a direction parallel to the surface plane of the device. That is, the net motion 95 of the seismic-mass 3 has both a component along the X-axis 97 and a component along the Y-axis 99. The motion depicted in FIG. 7 is consistent with the type of motion shown in FIG. 4.

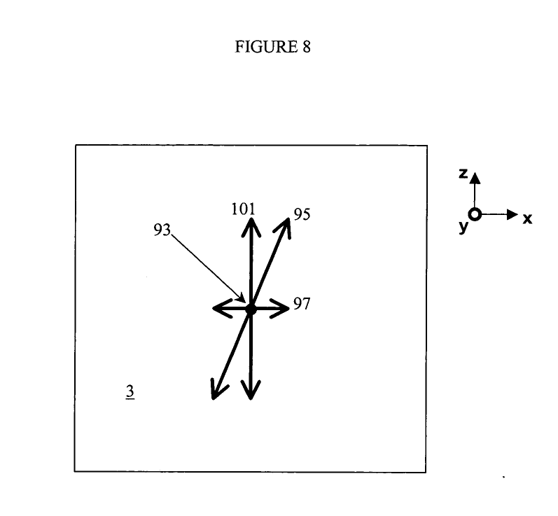

FIG. 8 is a cross-sectional simplified representation of the present invention depicting motion of the seismic-mass 3 along a direction partly parallel to the surface plane of the device and partly perpendicular to the surface plane of the device. That is, the net motion 95 of the seismic-mass 3 has both a component along the X-axis 97 and a component along the Z-axis 101. The motion depicted in FIG. 8 results from a combination of the type of motion shown in FIG. 3 and FIG. 4.

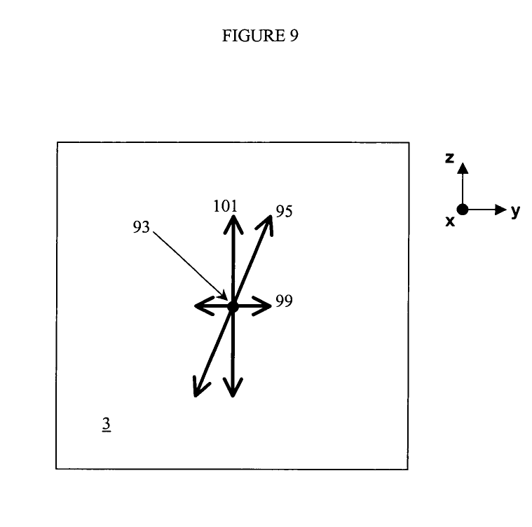

FIG. 9 is a cross-sectional simplified representation of the present invention depicting motion of the seismic-mass 3 along a direction partly parallel to the surface plane of the device and partly perpendicular to the surface plane of the device. That is, the net motion 95 of the seismic-mass 3 has both a component along the Y-axis 99 and a component along the Z-axis 101. The motion depicted in FIG. 9 results from a combination of the type of motion shown in FIG. 3 and FIG. 4.

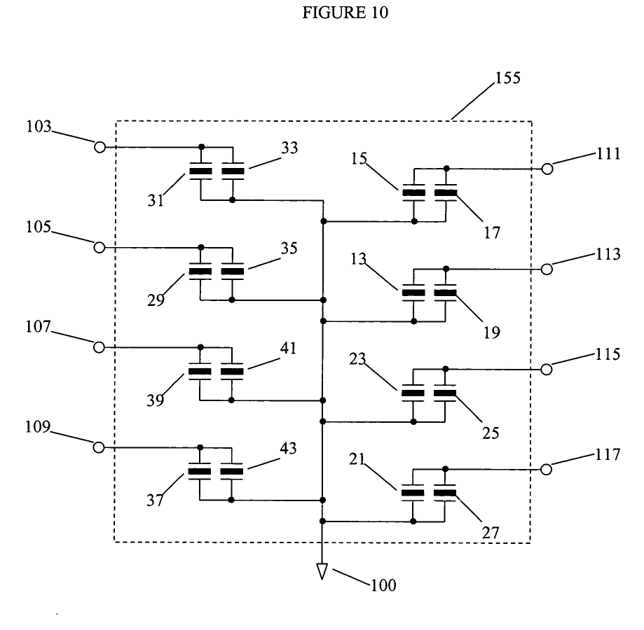

FIG. 10 is an electrical diagram showing electrical connections of the piezoelectric elements in FIG. 2 that provide a rate sensor according to the present invention. With the FIG. 10 electrical connections in conjunction with the FIG. 2 piezoelectric element arrangement, the device is primarily selective to the type of in-plane motion depicted in FIG. 4 and FIG. 7. That is, the difference between output signals 111 and 113 will be selective and proportional to motion of the seismic-mass 3 along the X-axis. Furthermore, the difference between output signals 115 and 117 will be selective and proportional to motion of the seismic-mass 3 along the Y-axis. In the embodiment of FIG. 10, the elements 15/17 and 13/19 operate as X-axis motion sensors while the elements 23/25 and 21/27 operate as Y-axis motion sensors. The elements 31, 33, 29, 35, 39, 41, 37, and 43 operate as actuators in FIG. 10 to create controlled motion of the seismic-mass 3 that is partly along the X-axis and partly along the Y-axis. Specifically, application of an electrical signal of first polarity 103 to 31/33 along with application of an electrical signal of second polarity 105 to 29/35 generates motion of the seismic-mass 3 partly along the X-axis and partly along the Y-axis as shown in FIG. 7. Similarly, application of an electrical signal of first polarity 107 to 39/41 along with application of an electrical signal of second polarity 109 to 37/43 generates motion of the seismic-mass 3 partly along the X-axis and partly along the Y-axis as shown in FIG. 7. Referring to FIG. 7, the magnitude of motion along the Y-axis is controlled by the relative magnitudes of the electrical signals 103, 105, 107, and 109. That is, due to the symmetry, if the magnitude of the electrical signals 103 and 105 applied to 31/33 and 29/35 is equal to the magnitude of the electrical signals 107 and 109 applied to 39/41 and 37/43, then the net Y-axis motion will be zero. If the magnitude of the electrical signals 103 and 105 applied to 31/33 and 29/35 is greater than the magnitude of the electrical signals 107 and 109 applied to 39/41 and 37/43, then the net Y-axis motion will be positive and proportional to the ratio of applied electrical signals (here, positive refers to in-phase with the X-axis motion according to the specified coordinate system). Conversely, if the magnitude of the electrical signals 103 and 105 applied to 31/33 and 29/35 is less than the magnitude of the electrical signals 107 and 109 applied to 39/41 and 37/43, then the net Y-axis motion will be negative and proportional to the ratio of applied electrical signals (here, negative refers to 180 degrees out of phase with the X-axis motion according to the specified coordinate system). In this manner the extent of seismic-mass 3 motion along the Y-axis is controlled by varying the relative magnitudes of the electrical signals 103, 105, 107, and 109. The outputs 111, 113, 115, and 117 provide a direct measurement of the X-axis and Y-axis motion of the seismic-mass 3.

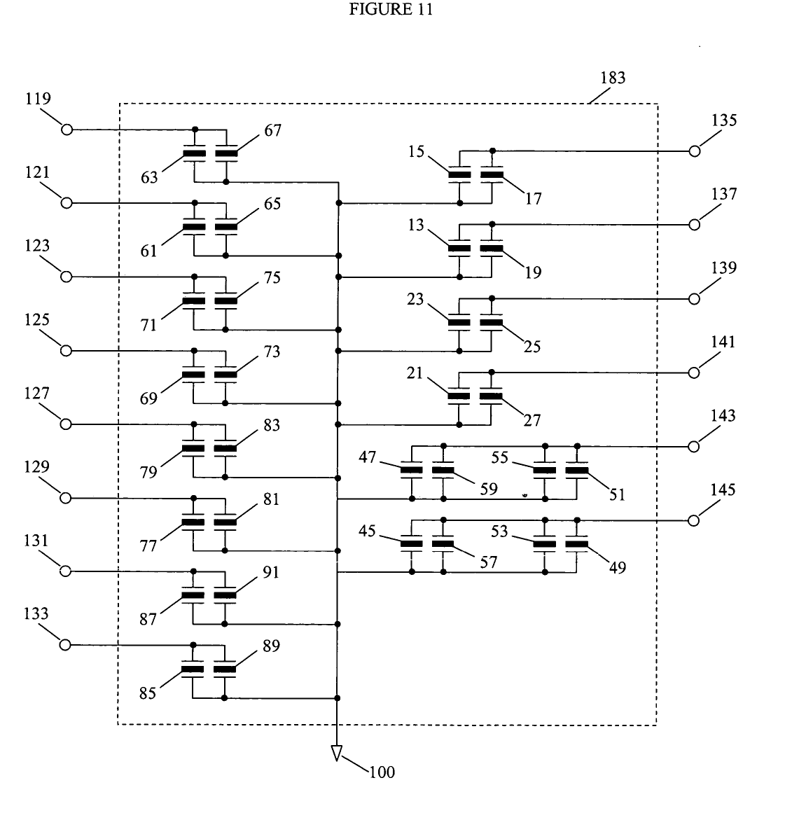

FIG. 11 is an electrical diagram showing electrical connections of the piezoelectric elements in FIG. 5 that provide a rate sensor according to the present invention. With the FIG. 11 electrical connections in conjunction with the FIG. 5 piezoelectric element arrangement, the device is selective to the types of motion depicted in FIG. 3, FIG. 4, FIG. 8, and FIG. 9. That is, the difference between output signals 135 and 137 will be selective and proportional to motion of the seismic-mass 3 along the X-axis. Furthermore, the difference between output signals 139 and 141 will be selective and proportional to motion of the seismic-mass 3 along the Y-axis. Lastly, the difference between output signals 143 and 145 will be selective and proportional to motion of the seismic-mass 3 along the Z-axis. In the embodiment of FIG. 11, the elements 15/17 and 13/19 operate as X-axis motion sensors, the elements 23/25 and 21/27 operate as Y-axis motion sensors, and the elements 47/59/55/51 and 45/57/53/49 operate as Z-axis motion sensors. The elements 61, 63, 65, 67, 69, 71, 73, and 75 operate as actuators in FIG. 11 to create controlled motion of the seismic-mass 3 that is partly along the X-axis and partly along the Z-axis. Because of the symmetric arrangement of the elements 61, 63, 65, 67, 69, 71, 73, and 75, motion imparted by these actuator elements along the Y-axis direction is negligible. Specifically, application of an electrical signal 119 of first polarity to 63/67 along with application of an electrical signal 121 of second polarity to 61/65 generates motion of the seismic-mass 3 partly along the X-axis and partly along the Z-axis as shown in FIG. 8. Similarly, application of an electrical signal 123 of first polarity to 71/75 along with application of an electrical signal 125 of second polarity to 69/73 generates motion of the seismic-mass partly along the X-axis and partly along the Z-axis as shown in FIG. 8. Referring to FIG. 8, the magnitude of motion along the X-axis is controlled by the relative magnitudes of the electrical signals 119, 121, 123, and 125. That is, due to the symmetry, if the magnitude of the electrical signals 119 and 121 is equal to the magnitude of the electrical signals 123 and 125, then the net X-axis motion will be zero. If the magnitude of the electrical signals 119 and 121 is greater than the magnitude of the electrical signals 123 and 125, then the net X-axis motion will be positive and proportional to the ratio of applied electrical signals (here, positive refers to in-phase with the Z-axis motion according to the specified coordinate system). Conversely, if the magnitude of the electrical signals 119 and 121 is less than the magnitude of the electrical signals 123 and 125, then the net X-axis motion will be negative and proportional to the ratio of applied electrical signals (here, negative refers to 180 degrees out of phase with the Z-axis motion according to the specified coordinate system). In this manner the extent of seismic-mass motion along the X-axis is controlled by varying the relative magnitudes of the electrical signals 119, 121, 123, and 125 in FIG. 11. The outputs 135, 137, 143, and 145 in FIG. 11 provide a direct measurement of the X-axis and Z-axis motions of the seismic-mass 3. Similarly, application of an electrical signal 127 of first polarity to 79/83 along with application of an electrical signal 129 of second polarity to 77/81 generates motion of the seismic-mass 3 partly along the Y-axis and partly along the Z-axis as shown in FIG. 9. Similarly, application of an electrical signal 131 of first polarity to 87/91 along with application of an electrical signal 133 of second polarity to 85/89 generates motion of the seismic-mass partly along the Y-axis and partly along the Z-axis as shown in FIG. 9. Referring to FIG. 9, the magnitude of motion along the Y-axis is controlled by the relative magnitudes of the electrical signals 127, 129, 131, and 133. That is, due to the symmetry, if the magnitude of the electrical signals 127 and 129 is equal to the magnitude of the electrical signals 131 and 133, then the net Y-axis motion will be zero. If the magnitude of the electrical signals 127 and 129 is greater than the magnitude of the electrical signals 131 and 133, then the net Y-axis motion will be positive and proportional to the ratio of applied electrical signals (here, positive refers to in-phase with the Z-axis motion according to the specified coordinate system). Conversely, if the magnitude of the electrical signals 127 and 129 is less than the magnitude of the electrical signals 131 and 133 then the net Y-axis motion will be negative and proportional to the ratio of applied electrical signals (here, negative refers to 180 degrees out of phase with the Z-axis motion according to the specified coordinate system). In this manner the extent of seismic-mass motion along the Y-axis is controlled by varying the relative magnitudes of the electrical signals 127, 129, 131, and 133 in FIG. 11. The outputs 139, 141, 143, and 145 in FIG. 11 provide a direct measurement of the Y-axis and Z-axis motion of the seismic-mass 3.

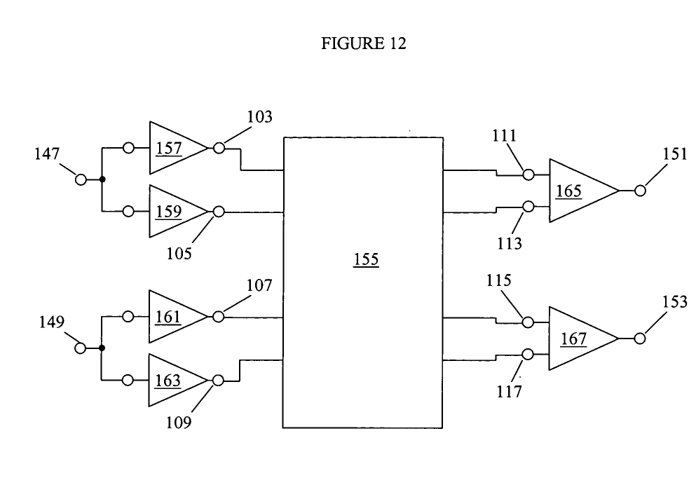

FIG. 12 shows one embodiment of electronics that would interface directly with the device depicted in FIG. 10 and FIG. 2. In FIG. 12, a transducer 155 contains the device described successively by FIGS. 1, 2, 6, and 10 whose primary modes of motion are depicted in FIGS. 4 and 7. The interface electronics in FIG. 12 provide two primary functions: first to electrically condition the electrical output signals from piezoelectric sensor elements in the transducer, and secondly to generate electrical drive signals to piezoelectric actuator elements in the transducer. The difference amplifiers 165 and 167 amplify the difference between two output signals from the transducer 155. Specifically, amplifier 165 in FIG. 12 amplifies the difference between output signals 111 and 113 from the transducer 155 and produces an output electrical signal 151 in proportion to the difference between output signals 111 and 113. In relation to the device depicted in FIG. 10 and FIG. 2, the output signal 151 in FIG. 12 is selectively proportional to motion of the seismic-mass 3 along the X-axis. Similarly, amplifier 167 in FIG. 12 amplifies the difference between output signals 115 and 117 from the transducer 155 and produces an output electrical signal 153 in proportion to the difference between output signals 115 and 117. In relation to the device depicted in FIG. 10 and FIG. 2, the output signal 153 in FIG. 12 is selectively proportional to motion of the seismic-mass 3 along the Y-axis. The drivers 157, 159, 161, and 163 in FIG. 12 apply electrical signals to piezoelectric actuator elements in the transducer 155. The drivers 157 and 159 provide a gain factor to the control signal 147 wherein the magnitude of the gain factor for driver 157 is equal to the magnitude of the gain factor for driver 159 but the two gain factors have opposite sign (i.e. one is an inverting amplifier, the other is a non-inverting amplifier). Specifically, in FIG. 12, the driver 157 applies a first gain factor of first polarity to the control signal 147 and applies the result 103 to the transducer. Also, in FIG. 12, the driver 159 applies a first gain factor of second polarity to the control signal 147 and applies the result 105 to the transducer 155. In this manner, drivers 157 and 159 create the differential electrical drive signals for piezoelectric actuator elements 31/33 and 29/35 in FIG. 2 and FIG. 10. The drivers 161 and 163 provide a gain factor to the control signal 149 wherein the magnitude of the gain factor for driver 161 is equal to the magnitude of the gain factor for driver 163 but the two gain factors have opposite sign (i.e. one is an inverting amplifier, the other is a non-inverting amplifier). Specifically, in FIG. 12, the driver 161 applies a first gain factor of first polarity to the control signal 149 and applies the result 107 to the transducer. Also, in FIG. 12, the driver 163 applies a first gain factor of second polarity to the control signal 149 and applies the result 109 to the transducer 155. In this manner, drivers 161 and 163 create the differential electrical drive signals for piezoelectric actuator elements 39/41 and 37/43 in FIG. 2 and FIG. 10. The drivers 157, 159, 161, and 163 in FIG. 12 generate the necessary differential actuator electrical signal from the pair of single-ended control electrical signals 147 and 149. In conjunction with the device of FIG. 10 and FIG. 2, the average magnitude of the control signals 147 and 149 controls the magnitude of X-axis motion of the seismic-mass, while the difference of the magnitudes of the control signals 147 and 149 controls the magnitude of Y-axis motion of the seismic-mass.

General operation for the embodiments described in FIGS. 1, 2, 10, and 12 is based on the Coriolis Effect, a derivative of Newton's first law of motion. In normal operation, FIG. 12 periodic control signals 147 and 149 are input to the device. The periodic control signals 147 and 149 create a first periodic motion of the seismic-mass 3 that is partly along the X-axis direction and partly along the Y-axis as shown in FIGS. 4, 6, and 7. If a rotation is applied around the Z-axis, a first Coriolis force forms in a direction partly along the X-axis and partly along the Y-axis and perpendicular to the first periodic motion. The first Coriolis force is proportional to the weight of the seismic-mass 3, the frequency of the first periodic motion, the magnitude of the first periodic motion, and the rate of rotation around the Z-axis. In FIG. 12, the output electrical signals 151 and 153 provide means for electrically measuring the extent of the first periodic motion and the extent of the first Coriolis force. In the embodiment of FIG. 12 and many other embodiments of the present invention, it may be desirable to apply the periodic control signals 147 and 149 at the fundamental mechanical resonant frequency associated with the first periodic motion. Operation at the resonant frequency provides a maximum amount of motion with the minimum applied signal voltage. According to the primary piezoelectric effect and details of the mechanical resonant behavior, the amplitude and phase of the output electrical signals 151 and 153 shift relative to the input periodic control signals 147 and 149 at the mechanical resonant frequency. The amplitude and phase shift provide means for maintaining the first periodic motion at the mechanical resonant frequency of the FIG. 12 device.

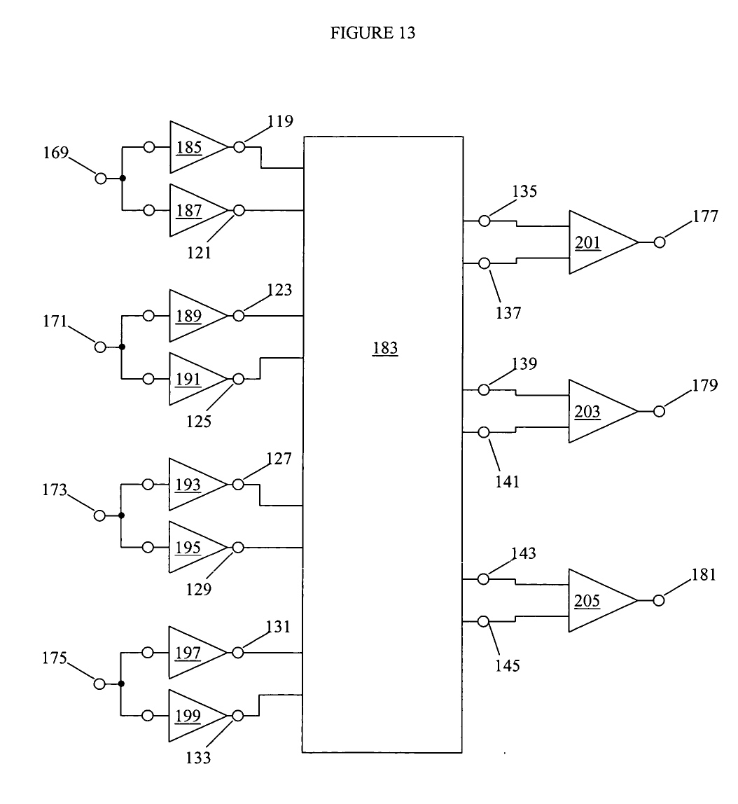

FIG. 13 shows a further embodiment of electronics that would interface directly with the device depicted in FIG. 11 and FIG. 5. In FIG. 13, a transducer 183 contains the device described successively by FIGS. 1, 5, 6, and 11 whose primary modes of motion are depicted in FIGS. 3, 4, 8, and 9. The interface electronics in FIG. 13 provide two primary functions: first to electrically condition the electrical output signals from piezoelectric sensor elements in the transducer 183, and secondly to generate electrical drive signals to piezoelectric actuator elements in the transducer 183. The amplifiers 201, 203, and 205 are difference amplifiers whose function is to amplify the difference between two output signals from the transducer 183. Specifically, amplifier 201 in FIG. 13 amplifies the difference between outputs 135 and 137 from the transducer 183 and produces an output electrical signal 177 in proportion to the difference between outputs 135 and 137. In relation to the device depicted in FIG. 11 and FIG. 5, output signal 177 in FIG. 13 is selectively proportional to motion of the seismic-mass 3 along the X-axis. Similarly, amplifier 203 in FIG. 13 amplifies the difference between outputs 139 and 141 from the transducer 183 and produces an output electrical signal 179 in proportion to the difference between outputs 139 and 141. In relation to the device depicted in FIG. 11 and FIG. 5, output 179 in FIG. 13 is selectively proportional to motion of the seismic-mass 3 along the Y-axis. Lastly, amplifier 205 in FIG. 13 amplifies the difference between outputs 143 and 145 from the transducer 183 and produces an output electrical signal 181 in proportion to the difference between outputs 143 and 145. In relation to the device depicted in FIG. 11 and FIG. 5, output 181 in FIG. 13 is selectively proportional to motion of the seismic-mass along the Z-axis. The drivers 185, 187, 189, 191, 193, 195, 197, and 199 in FIG. 13 apply electrical signals to piezoelectric actuator elements in the transducer. The drivers 185 and 187 provide a gain factor to the control signal 169 wherein the magnitude of the gain factor for driver 185 is equal to the magnitude of the gain factor for driver 187 but the two gain factors have opposite sign (i.e. one is an inverting amplifier, the other is a non-inverting amplifier). Specifically, in FIG. 13, the driver 185 applies a first gain factor of first polarity to the input signal 169 and applies the result 119 to the transducer 183. Also, in FIG. 13, the driver 187 applies a first gain factor of second polarity to the input signal 169 and applies the result 121 to the transducer 183. In this manner, drivers 185 and 187 create the differential electrical drive signals for piezoelectric actuator elements 63/67 and 61/65 in FIG. 5 and FIG. 11. The drivers 189 and 191 provide a gain factor to the control signal 171 wherein the magnitude of the gain factor for driver 189 is equal to the magnitude of the gain factor for driver 191 but the two gain factors have opposite sign (i.e. one is an inverting amplifier, the other is a non-inverting amplifier). Specifically, in FIG. 13, the driver 189 applies a first gain factor of first polarity to the input signal 171 and applies the result 123 to the transducer 183. Also, in FIG. 13, the driver 191 applies a first gain factor of second polarity to the input signal 171 and applies the result 125 to the transducer 183. In this manner, drivers 189 and 191 create the differential electrical drive signals for piezoelectric actuator elements 71/75 and 69/73 in FIG. 5 and FIG. 11. The drivers 185, 187, 189, and 191 in FIG. 13 generate the necessary differential actuator electrical signal from the pair of single-ended input control signals 169 and 171. In conjunction with the device of FIG. 11 and FIG. 5, the average magnitude of the input signals 169 and 171 controls the magnitude of Z-axis motion of the seismic-mass 3, while the difference of the magnitudes of the input signals 169 and 171 controls the magnitude of X-axis motion of the seismic-mass 3. The drivers 193 and 195 provide a gain factor to the control signal 173 wherein the magnitude of the gain factor for driver 193 is equal to the magnitude of the gain factor for driver 195 but the two gain factors have opposite sign (i.e. one is an inverting amplifier, the other is a non-inverting amplifier). Specifically, in FIG. 13, the driver 193 applies a first gain factor of first polarity to the input signal 173 and applies the result 127 to the transducer 183. Also, in FIG. 13, the driver 195 applies a first gain factor of second polarity to the input signal 173 and applies the result 129 to the transducer 183. In this manner, drivers 193 and 195 create the differential electrical drive signals for piezoelectric actuator elements 79/83 and 77/81 in FIG. 5 and FIG. 11. The drivers 197 and 199 provide a gain factor to the control signal 175 wherein the magnitude of the gain factor for driver 197 is equal to the magnitude of the gain factor for driver 199 but the two gain factors have opposite sign (i.e. one is an inverting amplifier, the other is a non-inverting amplifier). Specifically, in FIG. 13, the driver 197 applies a first gain factor of first polarity to the input signal 175 and applies the result 131 to the transducer 183. Also, in FIG. 13, the driver 199 applies a first gain factor of second polarity to the input signal 175 and applies the result 133 to the transducer 183. In this manner, drivers 197 and 199 create the differential electrical drive signals for piezoelectric actuator elements 87/91 and 85/89 in FIG. 5 and FIG. 11. The drivers 193, 195, 197, and 199 in FIG. 13 generate the necessary differential actuator electrical signal from the pair of single-ended input electrical signals 173 and 175. In conjunction with the device of FIG. 11 and FIG. 5, the average magnitude of the input signals 173 and 175 controls the magnitude of Z-axis motion of the seismic-mass 3, while the difference of the magnitudes of the input signals 173 and 175 controls the magnitude of Y-axis motion of the seismic-mass 3. General operation for the embodiments described in FIGS. 1, 5, 11, and 13 is based on the Coriolis Effect, a derivative of Newton's first law of motion. In normal operation, FIG. 13 periodic electrical signals 169 and 171 are input to the device. The periodic signals 169 and 171 create a first periodic motion of the seismic-mass 3 that is partly along the X-axis direction and partly along the Z-axis as shown in FIGS. 3, 4, 6, and 8. If a rotation is applied around the Y-axis, a first Coriolis force forms in a direction partly along the X-axis and partly along the Z-axis and perpendicular to the first periodic motion. The first Coriolis force is proportional to the weight of the seismic-mass, the frequency of the first periodic motion, the magnitude of the first periodic motion, and the rate of rotation around the Y-axis. In FIG. 13, the output electrical signals 177 and 181 provide means for electrically measuring the extent of the first periodic motion and the extent of the first Coriolis force. In the embodiment of FIG. 13 and many other embodiments of the present invention, it may be desirable to apply the periodic signals 169 and 171 at the fundamental mechanical resonant frequency associated with the first periodic motion. Operation at the resonant frequency provides a maximum amount of motion with the minimum applied electrical signal magnitude. According to the primary piezoelectric effect and details of the mechanical resonant behavior, the amplitude and phase of the electrical signals 177 and 181 shift relative to the input periodic signals 169 and 171 at the mechanical resonant frequency. The amplitude and phase shift provides a means for maintaining the first periodic motion at the mechanical resonant frequency of the FIG. 13 device.

Simultaneous with the FIG. 13 first periodic motion and associated effects described above, periodic electrical signals 173 and 175 are also input to the FIG. 13 device. The periodic signals 173 and 175 create a second periodic motion of the seismic-mass 3 that is partly along the Y-axis direction and partly along the Z-axis as shown in FIGS. 3, 4, 6, and 9. If a rotation is applied around the X-axis, a second Coriolis force forms in a direction partly along the Y-axis and partly along the Z-axis and perpendicular to the second periodic motion. The second Coriolis force is proportional to the weight of the seismic-mass, the frequency of the second periodic motion, the magnitude of the second periodic motion, and the rate of rotation around the X-axis. In FIG. 13, the output electrical signals 181 and 179 provide means for electrically measuring the extent of the second periodic motion and the extent of the second Coriolis force. In the embodiment of FIG. 13 and many other embodiments of the present invention, it may be desirable to apply the periodic signals 173 and 175 at the fundamental mechanical resonant frequency associated with the second periodic motion. Operation at the resonant frequency provides a maximum amount of motion with the minimum applied electrical signal magnitude. According to the primary piezoelectric effect and details of the mechanical resonant behavior, the amplitude and phase of the 181 and 179 electrical signals shift relative to the input periodic signals 173 and 175 at the mechanical resonant frequency. The amplitude and phase shift provide means for maintaining the second periodic motion at the mechanical resonant frequency of the FIG. 13 device.

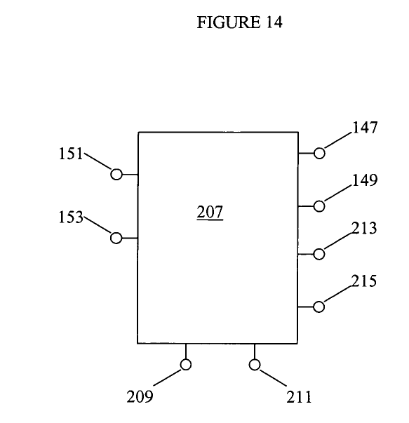

FIG. 14 provides a simplified functional block diagram of drive electronics 207 that operate with the device depicted in FIG. 12. In FIG. 14, the drive electronics 207 has four primary electrical output signals, 147, 149, 213, and 215 and four primary electrical input signals, 151, 153, 209, and 211. The electrical input signal 151 in FIG. 14 is proportional to X-axis motion of the seismic-mass 3 in FIGS. 10, 2, and 1. The electrical input signal 153 in FIG. 14 is proportional to Y-axis motion of the seismic-mass 3 in FIGS. 10, 2, and 1. The difference between outputs 213 and 215 is proportional to the difference between signal 153 and reference signal 211. A function of the drive electronics in FIG. 14 is to generate the appropriate output electrical signals 147 and 149 such that the magnitude of the input electrical signal 151 equals the reference signal 209, and the magnitude of the input electrical signal 153 equals the reference signal 211. Based on the described operation of the FIG. 12 device, the drive electronics will increase the average magnitude of the signals 147 and 149 until the magnitude of input signal 151 equals the reference input 209 magnitude. Conversely, if the magnitude of input signal 151 exceeds the reference input 209 magnitude, the drive electronics in FIG. 14 will reduce the average magnitude of the signals 147 and 149 until the magnitude of input signal 151 equals the reference input 209 magnitude. Also based on the described operation of the FIG. 12 device, the drive electronics will increase the difference of the magnitudes of the signals 147 and 149 (i.e. V[147]−V[149]) until the input signal 153 magnitude equals the reference input 211 magnitude. Conversely, if the input signal 153 magnitude exceeds the reference input 211 magnitude, the drive electronics in FIG. 14 will reduce the difference of the magnitudes of the signals 147 and 149 (i.e. V[147]−V[149]) until the input signal 153 magnitude equals the reference input 211 magnitude. A further function of the drive electronics in FIG. 14 is to maintain a preferred periodic motion of the seismic-mass 3 in the FIG. 12 device. In one embodiment, the preferred periodic motion is comprised of oscillation at the mechanical resonant frequency. In this embodiment, the drive electronics provide appropriate phase shift and electrical signal gain (according to the Nyquist criteria) to selectively force the periodic signal frequency to match the mechanical resonant frequency. It will be appreciated that many other suitable methods for forcing the device into resonance can be used without departing from the scope of the present invention.

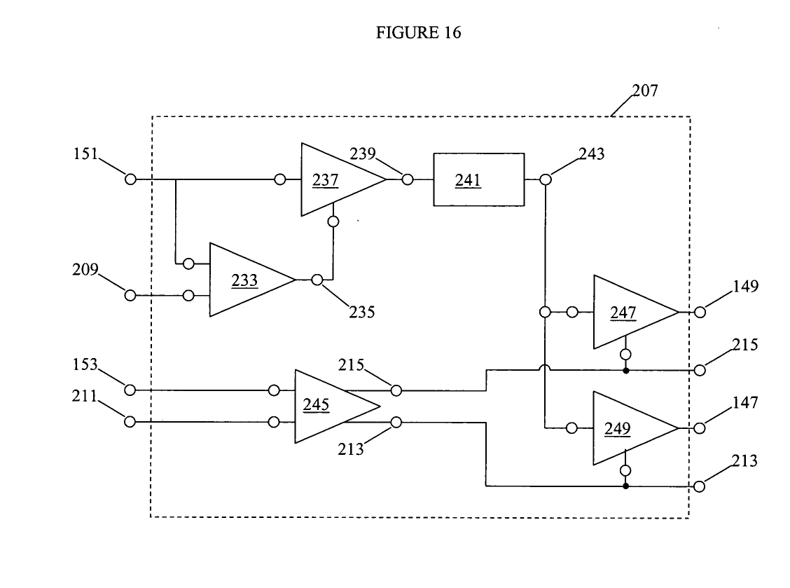

FIG. 16 shows an electrical schematic of one embodiment for the drive electronics of FIG. 14. In FIG. 16, a difference amplifier 233 generates an output 235 that is proportional to the difference between the input 151 magnitude and the input reference 209 magnitude. The output 235 is negative when input 151 magnitude is greater than input reference 209 magnitude, and positive when input magnitude 151 is less than input reference 209 magnitude. The amplifier 237 in FIG. 16 generates an output signal 239 that is proportional to the input electrical signal 151. The amplifier 237 sets the ratio of output signal 239 to input signal 151 according to the electrical signal 235. That is, signal 235 controls the signal gain of amplifier 237. A phase shift circuit 241 in FIG. 16 applies the necessary phase shift to signal 239 to sustain stable oscillations in the device according to the Nyquist criteria. The phase shift circuit generates the output 243 which is a copy of signal 239 but shifted in phase. Also, in FIG. 16, a second difference amplifier 245 generates a differential pair of output signals 215 and 213 wherein the difference between signals 215 and 213 is proportional to the difference between input signal 153 magnitude and input reference 211 magnitude. That is, the difference between output signals 215 and 213 is proportional to the difference between actual Y-axis motion of the seismic-mass 3 and the target magnitude of Y-axis motion of the seismic-mass 3. The output signal 213 is greater than the output signal 215 when the input signal 153 magnitude is less than the input reference 211 magnitude. Conversely, the output signal 213 is less than the output signal 215 when the input signal 153 magnitude is greater than the input reference 211 magnitude. The amplifier 247 in FIG. 16 generates the output signal 149 that is proportional to the electrical signal 243. The amplifier 247 sets the ratio of signals 149 and 243 according to the electrical signal 215. That is, signal 215 controls the signal gain of amplifier 247. In a similar manner, the amplifier 249 in FIG. 16 generates the output signal 147 that is proportional to the electrical signal 243. The amplifier 249 sets the ratio of signals 147 and 243 according to the electrical signal 213. That is, signal 213 controls the signal gain of amplifier 249.

The FIG. 16 electronics perform a plurality of functions in the overall operation of the rate sensor. The difference amplifier 233 compares the amplitude of the FIG. 2 seismic-mass motion along the X-axis and compares it with the target amplitude referenced by input reference signal 209. If the X-axis motion is less than the target amplitude, then input signal 151 magnitude will be less than input reference signal 209 and difference amplifier 233 will increase the value of signal 235, amplifier 237 signal gain will increase, the amplitude of both output signals 149 and 147 will increase, and the X-axis motion will increase. If the X-axis motion is greater than the target amplitude, then input signal 151 magnitude will be greater than input reference signal 209 and difference amplifier 233 will decrease the value of signal 235, amplifier 237 signal gain will decrease, the amplitude of both output signals 149 and 147 will decrease, and the X-axis motion will decrease. The difference amplifier 245 compares the amplitude of FIG. 2 seismic-mass motion along the Y-axis and compares it with the target amplitude referenced by input reference 211. If the Y-axis motion is less than the target amplitude, then input signal 153 magnitude will be less than input reference 211, difference amplifier 245 will increase the value of control signal 213, difference amplifier 245 will decrease the value of control signal 215, amplifier 247 signal gain will decrease, amplifier 249 signal gain will increase, the amplitude of output signal 147 will increase, the amplitude of output signal 149 will decrease, and the Y-axis motion will increase. If, on the other hand, the Y-axis motion is greater than the target amplitude, then input signal 153 magnitude will be greater than input reference 211, difference amplifier 245 will decrease the value of control signal 213, difference amplifier 245 will increase the value of control signal 215, amplifier 247 signal gain will increase, amplifier 249 signal gain will decrease, the amplitude of output signal 147 will decrease, the amplitude of output signal 149 will increase, and the Y-axis motion will decrease. In this manner, the FIG. 16 electronic circuit in conjunction with the device depicted in FIGS. 1, 2, 10, and 12 provides means for maintaining stable and controlled seismic motion along both the X-axis and Y-axis wherein the target levels of X-axis and Y-axis motion are set by the electrical reference signal inputs 209 and 211.

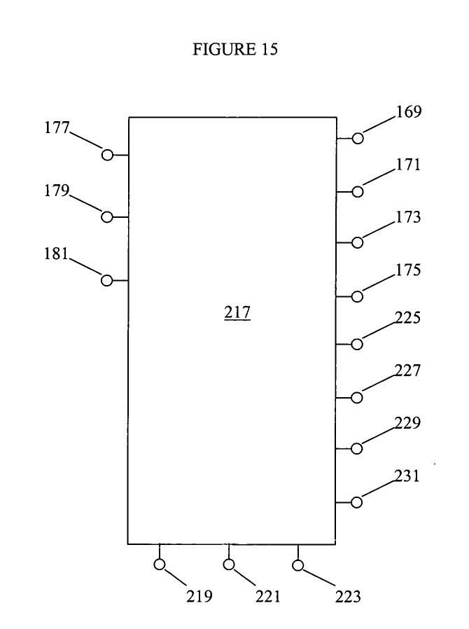

FIG. 15 provides a simplified functional block diagram of drive electronics that operate with the device depicted in FIG. 13. In FIG. 15, the drive electronics 217 has eight primary electrical output signals, 169, 171, 173, 175, 225, 227, 229, and 231 and six primary electrical input signals, 177, 179, 181, 219, 221, and 223. The electrical input signal 181 in FIG. 15 is proportional to Z-axis motion of the seismic-mass 3 in FIGS. 11, 5, and 1. The electrical input signal 177 in FIG. 15 is proportional to X-axis motion of the seismic-mass 3 in FIGS. 11, 5, and 1. The electrical input signal 179 in FIG. 15 is proportional to Y-axis motion of the seismic-mass 3 in FIGS. 11, 5, and 1. The difference between output signals 225 and 227 is proportional to the difference between input signal 177 and input reference 221. The difference between output signals 229 and 231 is proportional to the difference between input signal 179 and input reference 223. A function of the drive electronics block in FIG. 15 is to generate the appropriate output electrical signals 169, 171, 173, and 175 such that the magnitude of the input electrical signal 181 equals the input reference signal 219, the magnitude of the input electrical signal 177 equals the input reference signal 221, and the magnitude of the input electrical signal 179 equals the input reference signal 223. Based on the described operation of the FIG. 13 device, the drive electronics block will increase the average magnitude of the output signals 169, 171, 173, and 175 until the input signal 181 magnitude equals the input reference 219 magnitude. Conversely, if the input signal 181 magnitude exceeds the input reference 219 magnitude, the drive electronics block in FIG. 15 will reduce the average magnitude of the output signals 169, 171, 173, and 175 until the input signal 181 magnitude equals the input reference 219 magnitude. Also based on the described operation of the FIG. 13 device, the drive electronics block will increase the difference of the magnitudes of the output signals 169 and 171 until the input signal 177 magnitude equals the input reference 221 magnitude. Conversely, if the input signal 177 magnitude exceeds the input reference 221 magnitude, the drive electronics block in FIG. 15 will reduce the difference of the magnitudes of the output signals 169 and 171 until the input signal 177 magnitude equals the input reference 221 magnitude. Also based on the described operation of the FIG. 13 device, the drive electronics block will increase the difference of the output signals 173 and 175 until the input signal 179 magnitude equals the input reference 223 magnitude. Conversely, if the input signal 179 magnitude exceeds the input reference 223 magnitude, the drive electronics block in FIG. 15 will reduce difference of the output signals 173 and 175 until the input signal 179 magnitude equals the input reference 223 magnitude. A further function of the drive electronics block in FIG. 15 is to maintain a preferred periodic motion of the seismic-mass 3 in the FIG. 13 device. In one embodiment, the preferred periodic motion is comprised of oscillation at the mechanical resonant frequency. In this embodiment, the drive electronics provide appropriate phase shift and electrical signal gain (according to the Nyquist criteria) to selectively force the periodic signal frequency to match the mechanical resonant frequency. It will be appreciated that many other suitable methods for forcing the device into resonance can be used without departing from the scope of the present invention.

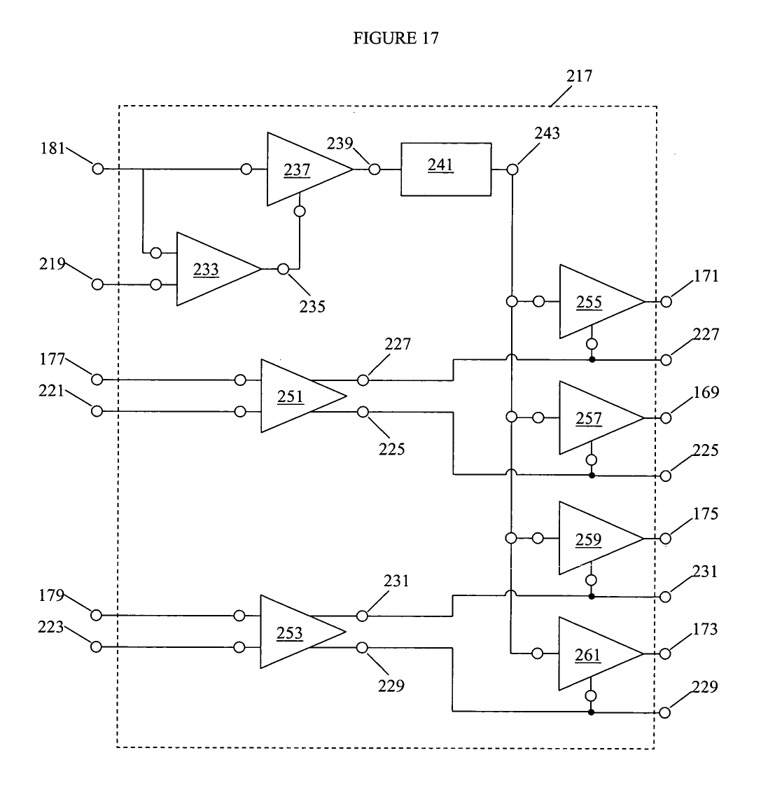

FIG. 17 shows an electrical schematic of one embodiment for the drive electronics summarized in FIG. 15. In FIG. 17, a difference amplifier 233 generates an output signal 235 that is proportional to the difference between the input signal 181 magnitude and the input reference signal 219. The output signal 235 output is negative when input signal 181 magnitude is greater than input reference signal 219, and positive when input signal 181 magnitude is less than input reference signal 219. The amplifier 237 in FIG. 17 generates an output signal 239 that is proportional to the input signal 181. The amplifier 237 sets the ratio of output signal 239 to input signal 181 according to the output signal 235 electrical signal. That is, output signal 235 controls the signal gain of amplifier 237. A phase shift circuit 241 in FIG. 17 applies the necessary phase shift to output signal 239 to sustain stable oscillations in the device according to the Nyquist criteria. The phase shift block generates the output signal 243 that is a copy of output signal 239 but shifted in phase. Also, in FIG. 17, a second difference amplifier 251 generates a differential pair of output signals 225 and 227 wherein the difference between output signals 225 and 227 is proportional to the difference between input signal magnitude 177 and input reference signal 221. The output signal 225 is greater than the output signal 227 when the input signal 177 magnitude is less than the input reference signal 221. Conversely, the output signal 225 is less than the output signal 227 when the input signal 177 magnitude is greater than the input reference signal 221. The amplifier 255 in FIG. 17 generates the output signal 171 that is proportional to the output signal 243. The amplifier 255 sets the ratio of output signal 171 to output signal 243 according to the electrical signal 227. That is, signal 227 controls the signal gain of amplifier 255. In a similar manner, the amplifier 257 in FIG. 17 generates the output signal 169 that is proportional to the output signal 243. The amplifier 257 amplifier sets the ratio of output signal 169 to output signal 243 according to the electrical signal 225. That is, electrical signal 225 controls the signal gain of amplifier 257. Also, in FIG. 17, a third difference amplifier 253 that generates a differential pair of output signals 229 and 231 wherein the difference between signals 229 and 231 is proportional to the difference between input signal 179 magnitude and input reference signal 223. The output signal 229 is greater than the output signal 231 when the input signal 179 magnitude is less than the input reference signal 223. Conversely, the output signal 229 is less than the output signal 231 when the input signal 179 magnitude is greater than the input reference signal 223. The amplifier 259 in FIG. 17 generates the output signal 175 that is proportional to the output signal 243. The amplifier 259 amplifier sets the ratio of output signal 175 to output signal 243 according to the output signal 231. That is, output signal 231 controls the signal gain of amplifier 259. In a similar manner, the amplifier 261 in FIG. 17 generates the output signal 173 that is proportional to the output signal 243. The amplifier 261 sets the ratio of output signal 173 to output signal 243 according to the output signal 229. That is, output signal 229 controls the signal gain of amplifier 261.

The FIG. 17 electronics perform a plurality of functions in the overall operation of the rate sensor. The difference amplifier 233 compares the amplitude of the FIG. 5 seismic-mass motion along the Z-axis and compares it with the target amplitude referenced by input reference signal 219. If the Z-axis motion is less than the target amplitude, then input signal 181 magnitude will be less than input reference signal 219 and difference amplifier 233 will increase the value of signal 235, amplifier 237 signal gain will increase, the amplitude of outputs 169, 171, 173, and 175 will all increase, and the Z-axis motion will increase. If the Z-axis motion is greater than the target amplitude, then input signal 181 magnitude will be greater than input reference signal 219 and difference amplifier 233 will decrease the value of signal 235, amplifier 237 signal gain will decrease, the amplitude of outputs 169, 171, 173, and 175 will all decrease, and the Z-axis motion will decrease. The difference amplifier 251 compares the amplitude of FIG. 5 seismic-mass motion along the X-axis and compares it with the target amplitude referenced by input reference signal 221. If the X-axis motion is less than the target amplitude, then input signal 177 magnitude will be less than input reference signal 221, difference amplifier 251 will increase the value of output signal 225, difference amplifier 251 will decrease the value of output signal 227, amplifier 255 signal gain will decrease, amplifier 257 signal gain will increase, the amplitude of output signal 169 will increase, the amplitude of output signal 171 will decrease, and the X-axis motion will increase. If, on the other hand, the X-axis motion is greater than the target amplitude, then input signal 177 magnitude will be greater than input reference signal 221, difference amplifier 251 will decrease the value of output signal 225, difference amplifier 251 will increase the value of output signal 227, amplifier 255 signal gain will increase, amplifier 257 signal gain will decrease, the amplitude of output signal 169 will decrease, the amplitude of output signal 171 will increase, and the X-axis motion will decrease. In this manner, the FIG. 17 electronic circuit in conjunction with the device depicted in FIGS. 1, 5, 11, and 13 provides means for maintaining stable and controlled seismic motion along both the Z-axis and X-axis wherein the target levels of Z-axis and X-axis motion are set by the input reference signal 219 and input reference signal 221. Furthermore, the difference amplifier 253 compares the amplitude of FIG. 5 seismic-mass motion along the Y-axis and compares it with the target amplitude referenced by input reference signal 223. If the Y-axis motion is less than the target amplitude, then input signal 179 magnitude will be less than input reference signal 223, difference amplifier 253 will increase the value of output signal 229, difference amplifier 253 will decrease the value of output signal 231, amplifier 259 signal gain will decrease, amplifier 261 signal gain will increase, the amplitude of output signal 173 will increase, the amplitude of output signal 175 will decrease, and the Y-axis motion will increase. If, on the other hand, the Y-axis motion is greater than the target amplitude, then input signal 179 magnitude will be greater than input reference signal 223, difference amplifier 253 will decrease the value of output signal 229, difference amplifier 253 will increase the value of output signal 231, amplifier 259 signal gain will increase, amplifier 261 signal gain will decrease, the amplitude of output signal 173 will decrease, the amplitude of output signal 175 will increase, and the Y-axis motion will decrease. In this manner, the FIG. 17 electronic circuit in conjunction with the device depicted in FIGS. 1, 5, 11, and 13 provides means for maintaining stable and controlled seismic motion along each of the Z-axis, X-axis, and Y-axis directions wherein the target levels of Z-axis, X-axis, and Y-axis motion are set by input reference signal 219, input reference signal 221, and input reference signal 223.

The embodiments presented above provide a variety of configurations for a solid-state rate sensor according to the present invention. The components described above and shown in FIGS. 1, 2, 6, 10, 12, 14, and 16 provide means for maintaining a stable oscillation of the seismic-mass along both the X-axis and Y-axis directions. This collection of components taken together provides the means for a solid-state sensor responsive to rotational rate around the Z-axis according to the present invention. The components described above and shown in FIGS. 1, 5, 6, 11, 13, 15, and 17 provide means for maintaining a stable oscillation of the seismic-mass along each of the X-axis, Y-axis, and Z-axis directions. This collection of components taken together provides the means for a solid-state sensor responsive to rotational rate around both the X-axis and Y-axis according to the present invention. An important feature of each of these embodiments and the present invention is that motion along multiple axes can be simultaneously measured and controlled. This is particularly important for a solid-state sensor based on the Coriolis effect. In the collective device described above and shown in FIGS. 1, 2, 6, 10, 12, 14, and 16 a primary oscillation is sustained along the X-axis so that a rotation about the Z-axis creates a Coriolis force in the Y-axis direction. However, in practical rate sensors there are inevitable inaccuracies in the manufacturing so that a transverse component of motion in the Y-axis direction exists even when there is no rotation. Unless the unintended Y-axis motion can be measured and controlled, significant inaccuracies will result when measuring rotation about the Z-axis. The present invention provides means for measuring and controlling the unintended Y-axis motion providing an improvement over the prior art. Similarly, in the collective device described above and shown in FIGS. 1, 5, 6, 11, 13, 15, and 17 a primary oscillation is sustained along the Z-axis so that a rotation about the X-axis creates a Coriolis force in the Y-axis direction and a rotation about the Y-axis creates a Coriolis force in the X-axis direction. However, in practical rate sensors there are inevitable inaccuracies in the manufacturing so that transverse components of motion in both the X-axis and Y-axis directions exist even when there is no rotation. Unless the unintended X-axis and Y-axis motions can be measured and controlled, significant inaccuracies will result when measuring rotation about the X-axis or Y-axis. The present invention provides means for measuring and controlling the unintended X-axis and Y-axis motions providing an improvement over the prior art.

The following discussion will describe several embodiments for extracting high-fidelity rotational rate electrical signals from the components described above.

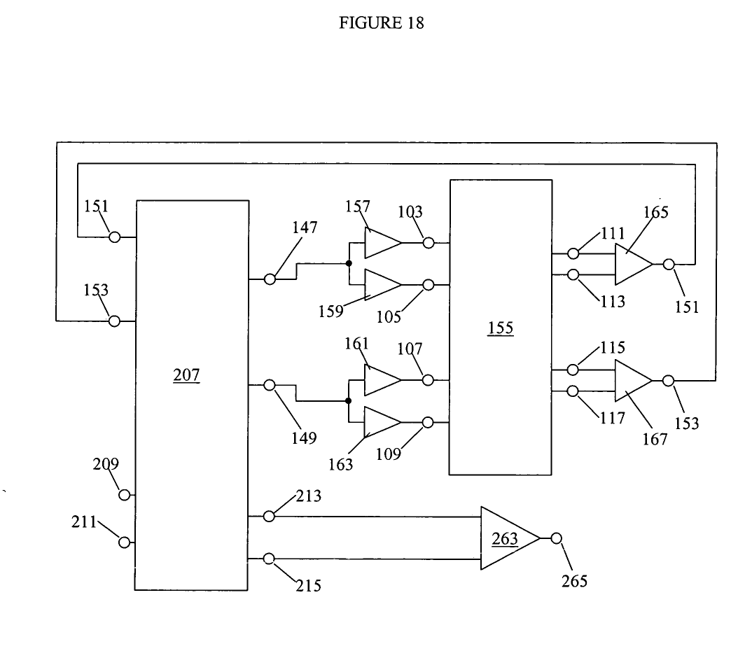

A further embodiment of a single-axis rotational rate sensor according to the present invention is shown in FIG. 18. In FIG. 18, the components of FIG. 12 and the components of FIG. 14 are connected to each other and further connected to a differential amplifier 263. The differential amplifier 263 generates an output signal 265 that is proportional to the difference between the electrical output signals 213 and 215 from the FIG. 14 circuitry. In the FIG. 18 embodiment, the input reference signal 211 to the drive electronics is set to zero. That is, the target magnitude of seismic-mass motion along the Y-axis direction is zero. As discussed above, the difference between output signals 213 and 215 is proportional to the magnitude of seismic motion along the Y-axis direction when the input reference signal 211 is set to zero. When the input reference signal 211 is set to zero, Y-axis motion is due to Coriolis forces produced in the transducer and proportional to the rotational rate around the Z-axis. The output 265 in the FIG. 18 electronics is thereby proportional to rotational rate around the Z-axis. The embodiment described in FIG. 18 therefore provides a single-axis rotational rate sensor according to the present invention.

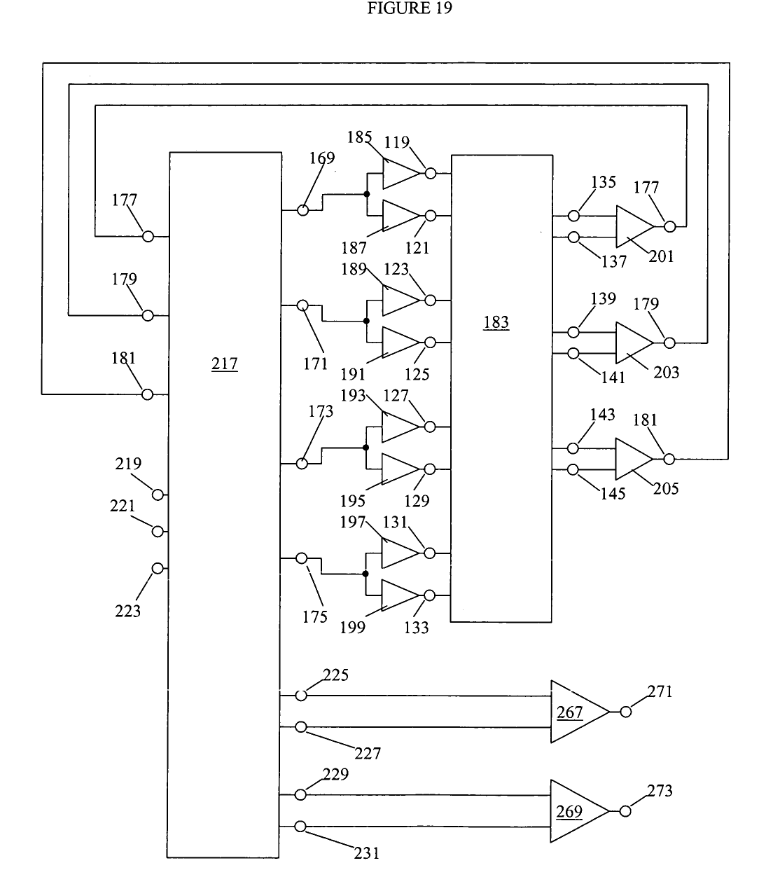

A further embodiment of a multi-axis rotational rate sensor according to the present invention is shown in FIG. 19. In FIG. 19, the components of FIG. 13 and the components of FIG. 15 are connected to each other and further connected to differential amplifiers 267 and 269. The differential amplifier 267 generates an output signal 271 that is proportional to the difference between the output signals 225 and 227 electrical signals from the FIG. 15 circuitry. The differential amplifier 269 generates an output signal 273 that is proportional to the difference between the output signals 229 and 231 from the FIG. 15 circuitry. In the FIG. 19 embodiment, the input reference signals 221 and 223 to the drive electronics are both set to zero. That is, the target magnitude of seismic-mass motion along both the Y-axis direction and X-axis direction is zero. As discussed above, the difference between output signals 225 and 227 is proportional to the magnitude of seismic motion along the X-axis direction when the input reference signal 221 is set to zero. When the input reference signal 221 input is set to zero, X-axis motion is due to Coriolis forces produced in the transducer 183 and proportional to the rotational rate around the Y-axis. Also, the difference between output signals 229 and 231 is proportional to the magnitude of seismic motion along the Y-axis direction when the input reference signal 223 is set to zero. When the input reference signal 223 input is set to zero, Y-axis motion is due to Coriolis forces produced in the transducer 183 and proportional to the rotational rate around the X-axis. The output signal 271 in the FIG. 19 electronics is thereby proportional to rotational rate around the Y-axis. The output signal 273 in the FIG. 19 electronics is thereby proportional to rotational rate around the X-axis. The embodiment described in FIG. 19 therefore provides a multi-axis rotational rate sensor according to the present invention.

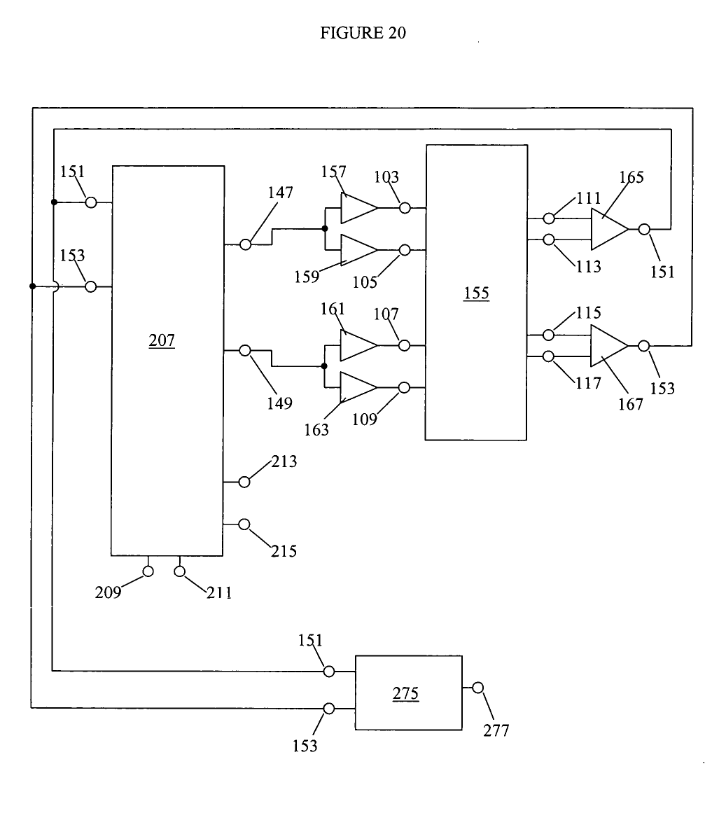

A further embodiment of a single-axis rotational rate sensor according to the present invention is shown in FIG. 20. In FIG. 20, the components of FIG. 12 and the components of FIG. 14 are connected to each other and further connected to a phase shift detection circuit 275. The phase shift detection circuit 275 generates an output signal 277 that is proportional to the phase difference between the input electrical signals 151 and 153 from the FIG. 12 circuitry. In the FIG. 20 embodiment, the input reference signal 211 to the drive electronics is set to a non-zero value. That is, the target magnitude of seismic-mass motion along the Y-axis direction is non-zero. The input electrical signal 153 will then be comprised of a component approximately in phase (or 180 degrees out of phase) with input electrical signal 151 and a component that is 90 degrees out of phase with input electrical signal 151. The component of input electrical signal 153 that is approximately in phase (or 180 degrees out of phase) with input electrical signal 151 is due to inaccuracies in the transducer production, mismatches in the electrical components, and motion intentionally introduced through the non-zero value of input reference 211. The component of input electrical signal 153 that is 90 degrees out of phase with input electrical signal 151 is due to Coriolis forces induced by rotation around the Z-axis. The input electrical signal 153 signal is a superposition of two periodic signals that are 90 degrees out of phase. The net phase of the input electrical signal 153 signal thereby shifts depending on the ratio of the in phase and out of phase magnitudes. In this manner, the phase shift of input electrical signal 153 is proportional to the rotational rate about the Z-axis. By using the input electrical signal 151 signal as a phase reference, the phase shift of input electrical signal 153 can be accurately measured. The phase shift detection circuit 275 converts the phase difference between input electrical signal 151 and input electrical signal 153 into the electrical output signal 277 that is proportional to rotational rate around the Z-axis. The embodiment described in FIG. 20 therefore provides a single-axis rotational rate sensor according to the present invention.

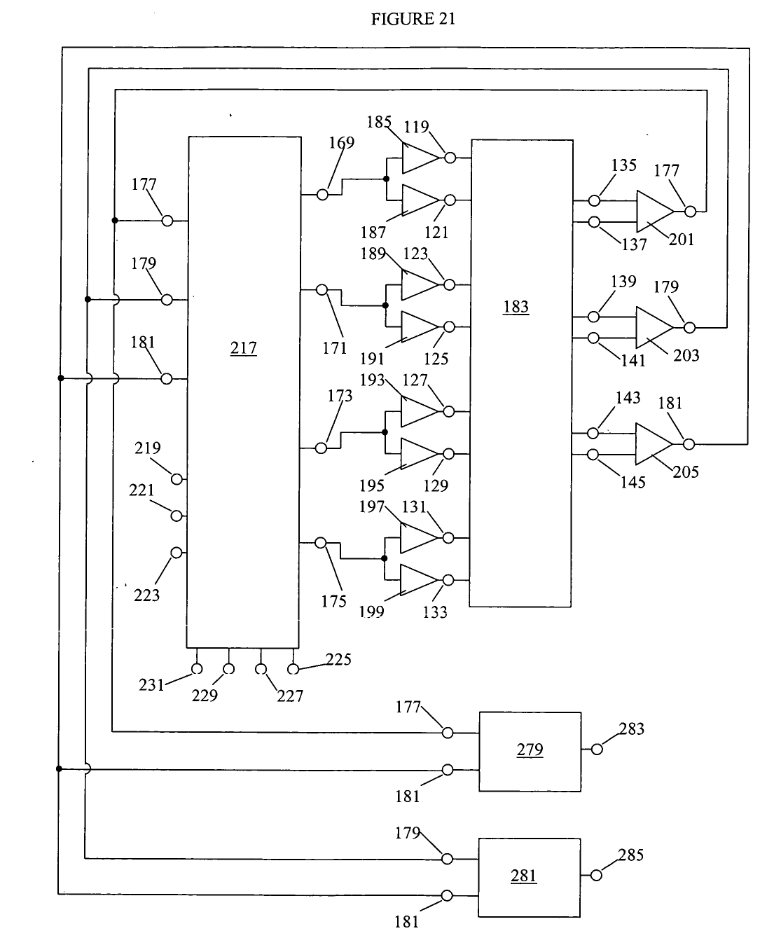

A further embodiment of a multi-axis rotational rate sensor according to the present invention is shown in FIG. 21. In FIG. 21, the components of FIG. 13 and the components of FIG. 15 are connected to each other and further connected to phase shift detection circuits 279 and 281. The phase shift detection circuit 281 generates an output signal 285 that is proportional to the phase difference between the electrical input signals 179 and 181 from the FIG. 13 circuitry. The phase shift detection circuit 279 circuit generates an output signal 283 that is proportional to the phase difference between the electrical signals 177 and 181 from the FIG. 13 circuitry. In the FIG. 21 embodiment, the input reference signal 221 and input reference signal 223 to the drive electronics are both set to a non-zero value. That is, the target magnitude of seismic-mass motion along both the Y-axis direction and X-axis direction is non-zero. The electrical signal 177 will then be comprised of a component approximately in phase (or 180 degrees out of phase) with electrical signal 181 and a component that is 90 degrees out of phase with electrical signal 181. The component of electrical signal 177 that is approximately in phase (or 180 degrees out of phase) with electrical signal 181 is due to inaccuracies in the transducer production, mismatches in the electrical components, and motion intentionally introduced through the non-zero value of input reference 221. The component of electrical signal 177 that is 90 degrees out of phase with electrical signal 181 is due to Coriolis forces induced by rotation around the Y-axis. The electrical signal 177 signal is a superposition of two periodic signals that are 90 degrees out of phase. The net phase of the electrical signal 177 signal thereby shifts depending on the ratio of the in phase and out of phase magnitudes. In this manner, the phase shift of electrical signal 177 is proportional to the rotational rate about the Y-axis. Similarly, the electrical signal 179 will also be comprised of a component approximately in phase (or 180 degrees out of phase) with electrical signal 181 and a component that is 90 degrees out of phase with electrical signal 181. The component of electrical signal 179 that is approximately in phase (or 180 degrees out of phase) with electrical signal 181 is due to inaccuracies in the transducer production, mismatches in the electrical components, and motion intentionally introduced through the non-zero value of input reference 223. The component of electrical signal 179 that is 90 degrees out of phase with electrical signal 181 is due to Coriolis forces induced by rotation around the X-axis. The electrical signal 179 signal is a superposition of two periodic signals that are 90 degrees out of phase. The net phase of the electrical signal 179 signal thereby shifts depending on the ratio of the in phase and out of phase magnitudes. In this manner, the phase shift of electrical signal 179 is proportional to the rotational rate about the X-axis. By using the electrical signal 181 signal as a phase reference, the phase shift of both electrical signal 177 and electrical signal 179 can be accurately measured. The phase shift detection circuit 279 circuit converts the phase difference between electrical signal 181 and electrical signal 177 into the output signal 283 that is proportional to rotational rate around the Y-axis. The phase shift detection circuit 281 circuit converts the phase difference between electrical signal 181 and electrical signal 179 into the output signal 285 that is proportional to rotational rate around the X-axis. The embodiment described in FIG. 21 therefore provides a multi-axis rotational rate sensor according to the present invention.

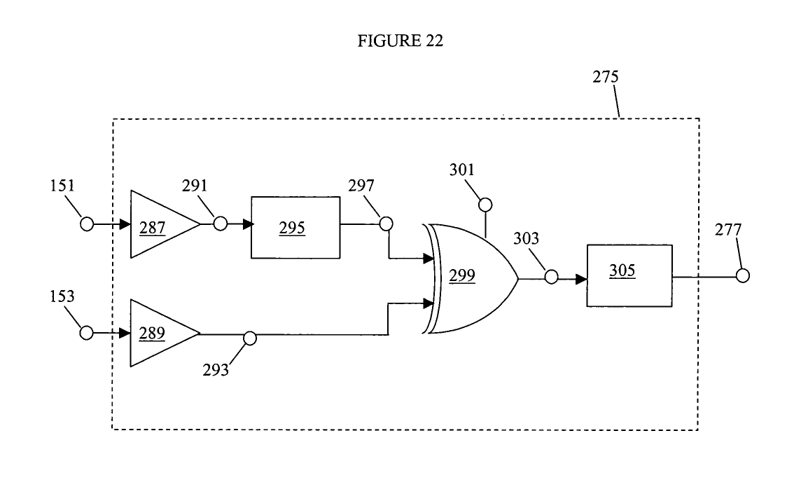

There are various ways to implement a phase-shift detection circuit and the subject has received a great deal of attention, particularly in the field of serial data communication. Implementations common in the prior art range from simple analog circuits to complex software-driven digital signal processing (DSP). In a preferred embodiment of the present invention, the circuit shown in FIG. 22 is implemented to perform the phase-shift detection function and generate the output signal 277 shown in FIG. 20. The circuit shown in FIG. 22 can also be implemented to perform the phase-shift detection function and generate the output signals 283 and 285 shown in FIG. 21.

In FIG. 22, a pair of amplifiers 287 and 289 boost the input signals 151 and 153 to generate digitized signals 291 and 293. A phase-shifter circuit 295 applies a phase shift to signal 291 to generate signal 297. The digital signals 293 and 297 are processed through an Exclusive-OR (XOR) digital logic gate 299 that generates an output signal 303 equal to input reference voltage 301 when either signal 297 is positive or signal 293 is positive. When both signal 297 and signal 293 are negative, or when both signal 297 and signal 293 are positive, output signal 303 is zero. An integrator circuit 305 averages the voltage level over time of output signal 303 to generate the output signal 277.

In an alternative embodiment, the integrator 305 in FIG. 22 may be eliminated, and the output signal 303 is then a pulse-width-modulated signal wherein the pulse width is proportional to phase and rotational rate.

There are many ways to implement a phase-shift detection circuit that provide an electrical output signal (output signal 277 in FIG. 20, output signals 283 and 285 in FIG. 21) in proportion to the relative phase between two periodic input signals. The preferred embodiment shown in FIG. 22 and described above is one such method and is not intended to limit the scope of the present invention.

From the above description and drawings, it will be understood by those of ordinary skill in the art that the particular embodiments shown and described are for purposes of illustration only and are not intended to limit the scope of the present invention. Those of ordinary skill in the art will recognize that the present invention may be embodied in other specific forms without departing from its spirit or essential characteristics. References to details of particular embodiments are not intended to limit the scope of the invention.

What is claimed is:

1. A solid-state rotational rate sensor device, comprising:
a first actuator element that generates a first force proportional to a first electrical drive signal;
a second actuator element that generates a second force proportional to a second electrical drive signal; and
a mass coupled to the first and second actuator elements;
wherein motion of the mass along a first direction is in proportion to sum of the first force and the second force, and motion of the mass along a second direction is in proportion to difference between the first force and the second force.

2. The solid-state rotational rate sensor device of claim 1, further comprising:
a first sensor element that generates a first electrical motion signal proportional to motion of the mass along the first direction;
a second sensor element that generates a second electrical motion signal proportional to motion of the mass along the second direction.

3. The solid-state rotational rate sensor device of claim 2 wherein each of the actuator elements and each of the sensor elements are comprised of piezoelectric capacitors.

4. The solid-state rotational rate sensor device of claim 2 wherein each of the actuator elements and each of the sensor elements are comprised of a differential pair of piezoelectric capacitors.

5. The solid-state rotational rate sensor device of claim 4 wherein each of the differential pair of piezoelectric capacitors is comprised of:
a shared common lower conductive electrode;
a shared common plate of piezoelectric material;
an upper conductive electrode; and
means for connecting the differential pair of piezoelectric capacitors to electronic circuitry.

6. The solid-state rotational rate sensor device of claim 2, further comprising:
a first reference electrical signal;
a second reference electrical signal; and
an electrical control circuit that generates the first and second electrical drive signals;
wherein the electrical control circuit adjusts sum of the first and second electrical drive signals so as to make a first electrical motion signal equal to the first reference electrical signal and adjusts difference between the first and second electrical drive signals so as to make a second electrical motion signal equal to the second reference electrical signal.
